(19) United States
(12) Patent Application Publication
(10) Pub. No.: US 2013/0183078 A1
(43) Pub. Date: Jul. 18, 2013

(54) Penholder

(71) Applicants: David Bennett, St. Albans (GB); Mark Bennett, St. Albans (GB)

(72) Inventors: David Bennett, St. Albans (GB); Mark Bennett, St. Albans (GB)

(21) Appl. No.: 13/805,955

(22) PCT Filed: Jun. 22, 2011
(86) PCT No.: PCT/GB2011/051174

§ 371 Date: Mar. 28, 2013

(30) Foreign Application Priority Data
Jun. 22, 2010 (GB) 1010467.7

(51) Int. Cl. B43K 23/00

(52) U.S. Cl. CPC B43K 23/001
USPC 401/131

(57) ABSTRACT

A penholder comprising a base arranged to receive and removably engage a pen, a retraction device attachable to the base, a tether connectable at one end to the base and the other to a pen and a suction cup connected to the base and configured to enable the base to be removably attached to surfaces.

This National Stage Application claims priority to PCT/GB2011/051174 (WO 2011/161453) entitled “Penholder” and filed on Jun. 22, 2011, which is a PCT Application based on GB 1010467.7 entitled “Penholder” and filed on Jun. 22, 2010, both of which are commonly-owned and incorporated herein in their entirety.

This invention relates to a penholder. The penholder may be used to non-permanently fix the position of a pen.

Penholders are often used to keep pens connected for a single position and to hold them when not in use. Examples of such a penholder are described, for example in U.S. Pat. No. 7,150,575 where a stand includes a retractable tether to which a pen is attached. A tether is used to enable the pen to be located in one place.

However, often the stands associated with these tethers are either large, and therefore difficult to relocate, or fixed permanently in one position and thus cannot be relocated. This means that if it is desired to fix the pen in a different position, for example, if the pen's user wishes to use a different desk, or the desk is being replaced it is difficult to do so.

In accordance with the present invention there is provided a penholder comprising a base arranged to receive and removably engage a pen, a retraction device attachable to the base, a tether connectable at one end to the base and the other to a pen, a suction cup connected to the base and configured to enable the base to be removably attached to surfaces. The suction cup, keeps the penholder in a single position, unless a user chooses to change the position of the penholder. The tether keeps the connection between the penholder and the pen in order that the pen cannot readily be removed from the penholder but can still be moved a sufficient distance to be used.

The retraction device may be disposed within the base in order to minimise the size of the penholder.

The base may be provided with a cavity to receive and removably engage the pen. Alternatively it may be provided with a ledge upon which to rest the pen. This helps to fix the pen in a single position when it is not in use.

Optionally, the retraction device is disposed within the cavity and may take up part of the cavity. This further minimises the size of the penholder.

The base may be a projection from the suction cup.

Preferably the height of the base is less than the length of the pen

The retraction device may include a wheel around which the tether is wound. The retraction device may also include a stop device to prevent retraction of the tether. This will allow a user to fix the tether at a required length in order that they can use the pen without any other force being applied to the pen by the tether.

A specific embodiment of the present invention will now be described by reference to the following drawings in which:

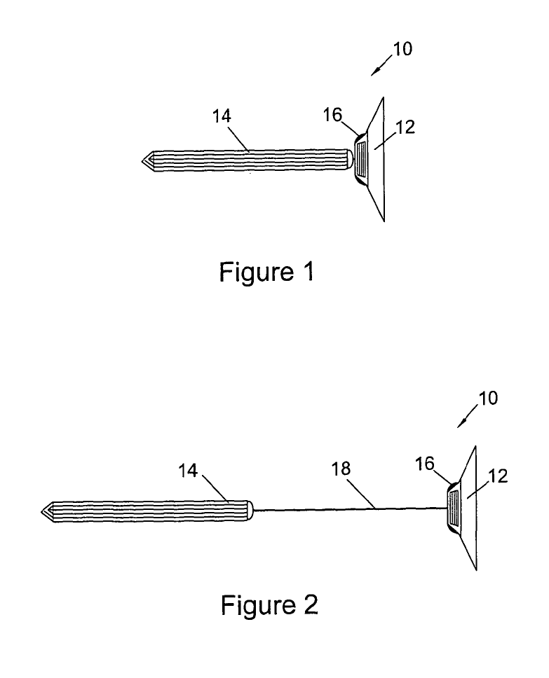

FIG. 1 illustrates a penholder where the tether is retracted within the penholder; and

FIG. 2 illustrates a penholder where the tether is extended.

FIGS. 1 and 2 illustrate the penholder 10 of the present invention. The penholder 10 includes a suction cup 12 and a tether 18 connecting a pen 14 to the suction cup 12. The suction cup 12 is suitable for attaching the penholder 10 to a surface, such as a the top surface of a desk, in order that a user cannot move the penholder 10 unintentionally.

The tether 18 is connected at one end to a pen 14 and at the other to a retraction device (not shown) such as a ratchet switch. The retraction device is situated with a projection 16 from the suction cup 12 and acts to allow the tether 18 to be pulled from the suction cup 12 allowing the pen 14 to be moved away from the suction cup 12 to a distance where it can be used.

The retraction device may be any suitable device. For example, it may include a ratchet switch which allows the tether to be pulled to a desired length and held there until the user has finished with the pen. When the user has finished with the pen the switch can be opened and the tether retracted using the retraction device.

Alternatively, the retraction device may include a spring mechanism for letting the tether out when the pen attached to the tether is in use and retract the tether together with the pen when the pen is not in use.

The retraction device is preferably situated within a projection of the penholder; however, it may be attached in any suitable position.

The tether may be made for any suitable material, for example, it may comprise a nylon tether or rope. Additionally, it may be of any length desired.

1. A penholder comprising:
i) a base arranged to receive and removably engage a pen;
ii) a retraction device attachable to the base; and
iii) a tether connectable at one end to the base and the other to a pen;
iv) a suction cup connectable to the base and configured to enable the base to be removably attached to surfaces.

2. A penholder as claimed in claim 1 wherein the retraction device is disposed within the base.

3. A penholder as claimed in claim 1 wherein the base is provided with a cavity to receive and removably engage the pen.

4. A penholder as claimed in claim 3 wherein the retraction device is disposed within the cavity.

5. A penholder as claimed in claim 1, wherein the base comprises a projection from the suction cup.

6. A penholder as claimed in claim 1, wherein the height of the base is less than the length of the pen

7. A penholder as claimed in claim 1, wherein the retraction device includes a wheel around which the tether is wound.

8. A penholder as claimed in claim 1, wherein the retraction device includes a stop device to prevent retraction of the tether.

9. A penholder substantially as herein described with reference to and as shown in any combination of the accompanying drawings.
